(19) United States
(12) Patent Application Publication
(10) Pub. No.: US 2025/0306199 A1
(43) Pub. Date: Oct. 2, 2025

(54) REGIONAL FIVE-DIMENSIONAL IMAGING METHOD, APPARATUS, DEVICE AND STORAGE MEDIUM

(71) Applicants: SHENZHEN TECHNOLOGY INSTITUTE OF URBAN PUBLIC SAFETY, Shenzhen (CN); SHENZHEN SCIENCE AND TECHNOLOGY INSTITUTE OF URBAN SAFETY DEVELOPMENT, Shenzhen (CN)

(72) Inventors: Yuzhou LIU, Shenzhen (CN); Zhongqi SHI, Shenzhen (CN); Qingrui YUE, Shenzhen (CN); Hong ZHANG, Shenzhen (CN); Haoxuan DUAN, Shenzhen (CN); Wenxi CAO, Shenzhen (CN); Tiandong CHEN, Shenzhen (CN); Lu TIAN, Shenzhen (CN); Wei ZHANG, Shenzhen (CN)

(73) Assignees: SHENZHEN TECHNOLOGY INSTITUTE OF URBAN PUBLIC SAFETY, Shenzhen (CN); SHENZHEN SCIENCE AND TECHNOLOGY INSTITUTE OF URBAN SAFETY DEVELOPMENT, Shenzhen (CN)

(21) Appl. No.: 19/237,182

(22) Filed: Jun. 13, 2025

Related U.S. Application Data
(63) Continuation of application No. PCT/CN2024/099368, filed on Jun. 14, 2024.

(30) Foreign Application Priority Data
Jun. 21, 2023 (CN) 202310737840.5

(51) Int. Cl. G01S 13/90

(52) U.S. Cl. CPC G01S 13/9005

(57) ABSTRACT

Disclosed are a regional five-dimensional imaging method, an apparatus, a device, and a storage medium. The method includes: detecting, based on the differential interference data, through a preset region growth network, reliable single permanent scatterers (SPSs) in a target region corresponding to the target interference measurement data; constructing, based on all SPSs in the preset region growth network, a local star network; and detecting, through the local star network, a target remaining SPS and all double permanent scatterers (DPSs) in the target region, and performing, based on the reliable SPSs, the target remaining SPS and all the DPSs, five-dimensional imaging on the target region.

### CROSS-REFERENCE TO RELATED APPLICATIONS

The present application is a continuation application of International Application No. PCT/CN2024/099368, filed on Jun. 14, 2024, which claims priority to Chinese Patent Application No. 202310737840.5, filed on Jun. 21, 2023. The disclosures of the above-mentioned applications are incorporated herein by reference in their entireties.

### TECHNICAL FIELD

The present application relates to the technical field of synthetic aperture radar interference measurement, and in particular, to a regional five-dimensional imaging method and a regional five-dimensional imaging apparatus, a regional five-dimensional imaging device, and a storage medium.

### BACKGROUND

In order to solve the “overlay” problem of dense urban areas of buildings, synthetic aperture radar (SAR) tomography has emerged. The SAR tomography technology uses a multi-baseline sensor (such as a satellite-borne, airborne, ground-based SAR, etc.) to measure the same region at different angles, so as to form a synthetic aperture upward in a third three-dimensional elevation in addition to distance and azimuth direction, thereby achieving a real three-dimensional imaging effect. However, due to the fact that multi-baseline simultaneous imaging cannot be achieved in the actual imaging process, the SAR tomography technology also adopts a repeated observation mode. At this time, the atmosphere phase screen (APS) of the whole area needs to be removed before data processing, so that the APS is prevented from reducing the quality of tomographic imaging.

In an existing solution, a reference network technology constructed based on a permanent scatterer (PS) may be applied to SAR tomography, so that an APS does not need to be removed in advance. However, the existing reference network generally cannot cover the entire research area, which affects the area imaging quality.

The foregoing content is only used to assist in understanding the technical solutions of the present application, and does not indicate that the foregoing content is an admission that the foregoing content is the related art.

### SUMMARY

The main objective of the present application is to provide a regional five-dimensional imaging method, a regional five-dimensional imaging apparatus, a regional five-dimensional imaging device, and a storage medium, which aim to solve the technical problem in the related art that a network applied to region imaging in SAR tomography cannot cover the entire research region and affect regional imaging quality.

To achieve the foregoing objective, the present application provides a regional five-dimensional imaging method, which includes the following steps.
preprocessing target interference measurement data to obtain processed differential interference data;
detecting, based on the differential interference data, reliable single permanent scatterers (SPSs) in a target region corresponding to the target interference measurement data through a preset region growth network;
constructing a local star network based on all SPSs in the preset region growth network; and
detecting, through the local star network, a target remaining SPS and all double permanent scatterers (DPSs) in the target region, to perform five-dimensional imaging on the target region based on the reliable SPSs, the target remaining SPS and all the DPSs.

In addition, in order to achieve the above purpose, the present application further provides a regional five-dimensional imaging device, including a regional five-dimensional imaging device, a memory, a processor, and a regional five-dimensional imaging program stored on the memory and executable on the processor. The regional five-dimensional imaging program is configured to implement the regional five-dimensional imaging method as described above.

In addition, in order to achieve the foregoing objective, the present application further provides a storage medium, which stores a regional five-dimensional imaging program. When the regional five-dimensional imaging program is executed by a processor, the regional five-dimensional imaging method as described above is implemented.

The present application discloses the following steps: preprocessing target interference measurement data to obtain processed differential interference data; detecting, based on the differential interference data, reliable SPSs in a target region corresponding to the target interference measurement data through a preset region growth network; constructing a local star network based on all SPSs in the preset region growth network; and detecting, through the local star network, a target remaining SPS and all DPSs in the target region, to perform five-dimensional imaging on the target region based on the reliable SPSs, the target remaining SPS and all the DPSs. In the present application, the reliable SPS in the target region is detected through the preset region growth network, the local star network is constructed based on all the SPSs in the preset region growth network to detect the target remaining SPS and all the DPSs in the target region, and finally, five-dimensional imaging of the target area is performed based on the reliable SPS, the target remaining SPS and all the DPSs, so that the technical problem that the area imaging quality is affected due to the fact that the network applied to area imaging in SAR tomography cannot cover the whole research area in the related art is solved.

### BRIEF DESCRIPTION OF THE DRAWINGS

FIG. 1 is a schematic structural diagram of a regional five-dimensional imaging device in a hardware operating environment according to an embodiment of the present application.

FIG. 2 is a schematic flowchart of a regional five-dimensional imaging method according to an embodiment of the present application.

FIG. 3 is a principle schematic diagram of SAR tomography in the regional five-dimensional imaging method according to an embodiment of the present application.

FIG. 4 is a schematic flowchart of a regional five-dimensional imaging method according to another embodiment of the present application.

FIG. 5 is a schematic flowchart of a region growth algorithm in the regional five-dimensional imaging method according to another embodiment of the present application.

FIG. 6 is a schematic flowchart of establishing a maximum connected network in the regional five-dimensional imaging method according to another embodiment of the present application.

FIG. 7 is a structural block diagram of a regional five-dimensional imaging apparatus according to an embodiment of the present application.

Implementations, functional features and advantages of the present application will be further described with reference to the accompanying drawings in combination with the embodiments.

### DETAILED DESCRIPTION OF THE EMBODIMENTS

It should be understood that the specific embodiments described herein are only used to explain the present application and are not intended to limit the present application.

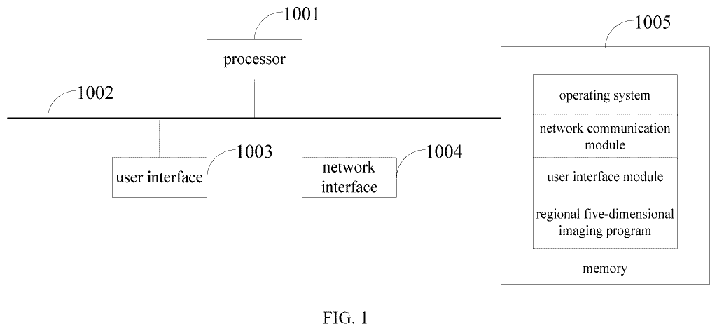

FIG. 1 is a schematic structural diagram of a regional five-dimensional imaging device in a hardware operating environment according to an embodiment of the present application.

As shown in FIG. 1, the regional five-dimensional imaging device may include a processor 1001, such as a central processing unit (CPU), a communication bus 1002, a user interface 1003, a network interface 1004, and a memory 1005. The communication bus 1002 is configured to implement connection and communication between these components. The user interface 1003 may include a display, an input unit such as a keyboard. The user interface 1003 may further include a standard wired interface and a wireless interface. The network interface 1004 may include a standard wired interface, a wireless interface (such as a wireless-fidelity (Wi-Fi) interface). The memory 1005 may be a high-speed random access memory (RAM), or may be a stable non-volatile memory (NVM), such as a magnetic disk memory. The memory 1005 may alternatively be a storage apparatus independent of the foregoing processor 1001.

Persons skilled in the art may understand that the structure shown in FIG. 1 does not constitute a limitation on the regional five-dimensional imaging device, and may include more or fewer components than those shown in the figure, or a combination of some components, or differently arranged components.

As shown in FIG. 1, the memory 1005 as a storage medium may include an operating system, a network communication module, a user interface module, and a regional five-dimensional imaging program.

In the regional five-dimensional imaging device shown in FIG. 1, the network interface 1004 is mainly configured to perform data communication with a network server. The user interface 1003 is mainly configured to perform data interaction with a user. The processor 1001 and the memory 1005 in the regional five-dimensional imaging device of the present application may be disposed in a regional five-dimensional imaging device, and the regional five-dimensional imaging device invokes the regional five-dimensional imaging program stored in the memory 1005 by using the processor 1001, and performs the regional five-dimensional imaging method provided in the embodiments of the present application.

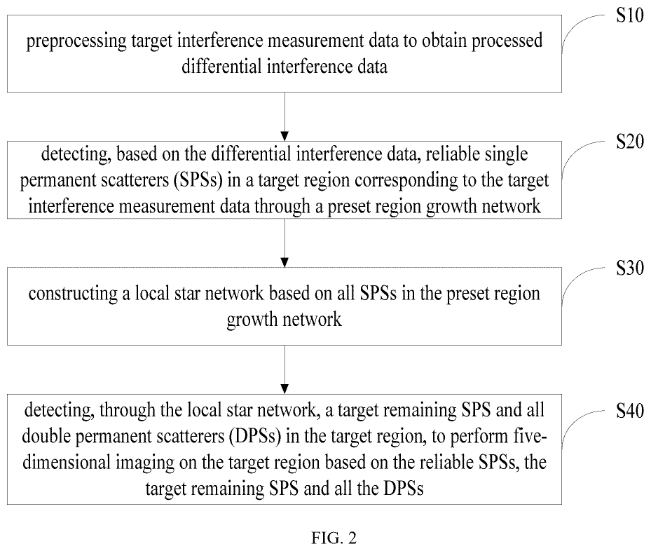

The embodiments of the present application provide a regional five-dimensional imaging method. As shown in FIG. 2, FIG. 2 is a schematic flowchart of a regional five-dimensional imaging method according to an embodiment of the present application.

In this embodiment, the regional five-dimensional imaging method includes the following steps:

Step S10: preprocessing the target interference measurement data and obtaining processed differential interference data.

It should be noted that the execution body of the method in this embodiment may be a regional five-dimensional imaging device for five-dimensional imaging of urban areas with dense buildings, or other regional five-dimensional imaging systems capable of implementing the same or similar functions and including the regional five-dimensional imaging device. The regional five-dimensional imaging method provided in the embodiments and the following embodiments is specifically described in this embodiment by using a regional five-dimensional imaging system (hereinafter referred to as a system for short).

It should be understood that the target interference measurement data may be two complex-valued images (both amplitude and phase image) data observed in the target region, such as interferometric synthetic aperture radar (InSAR) data. InSAR is a technology that uses two SAR images of the same area as the basic processing data, obtains the interference image by calculating the phase difference between the two SAR images, and then obtains the terrain elevation data from the interference fringes through phase unwrapping.

It may be understood that the differential interference data may be data obtained after amplitude calibration and differential interference on the target interference measurement data.

In a specific implementation, InSAR data of the target region may be obtained, and amplitude calibration and differential interference preprocessing are performed on the InSAR data to obtain processed differential interference data.

Step S20: detecting, based on the differential interference data, a reliable SPS in a target region corresponding to the target interference measurement data through a preset region growth network.

It should be noted that the preset region growth network may be a network that detects a SPS point meeting requirements in the SAR image of the target region, and may detect a reliable SPS in the SAR image.

It should be understood that the target region may be any urban areas with dense buildings, which is not limited in this embodiment.

It may be understood that the reliable SPS may be a SPS point determined in the SAR image corresponding to the target region.

In a specific implementation, the preset region growth network may be constructed by using a region growth algorithm. The region growth algorithm may be one of image segmentation technologies, and a basic idea of the region growth algorithm is to merge pixel points with similar properties together. A seed point is specified for each region to serve as a starting point of growth, then pixel points in the area around the seed point and seed point are compared, and points with similar properties are merged to continue to grow outwards until pixels that do not meet the condition are included. In this embodiment, the method may be introduced into the PS network construction, after preprocessing the two registered SAR images of the target area, one of the candidate SPS points is selected as the seed point. Then, certain principles are set, and based on the differential interference data obtained through processing, the seed point is connected with other candidate SPSs around them that meet this principle, and then continue to grow outward until a reference network that can cover the entire target region is constructed, that is, the above-mentioned preset region growth network.

Step S30: constructing a local star network based on all the SPSs in the preset region growth network.

It should be noted that the local star network may be a network for verifying SPS other than reliable SPS in the target region and a DPS. A specific network type is not limited in this embodiment.

It should be understood that step S30 may specifically include obtaining remaining SPSs based on all SPSs in the preset region growth network; and screening the remaining SPSs through an amplitude threshold to obtain candidate PS, and constructing a local star network based on the candidate PS.

It may be understood that the remaining SPSs may be SPSs remaining in the target region other than the SPSs that have been detected by the preset region growth network. In practical applications, after building the first layer of preset region growth network, all SPSs in the preset region growth network can be used as reference points to construct the second layer of local star network to detect the remaining SPSs and all DPSs in the target area.

It should be noted that, since the pixel including the DPS does not display the stability of the amplitude deviation index (ADI), in the local star network, the candidate DPS may not be screened by using the ADI. However, since both the SPS and the DPS have high reflectivity, the pixels may be selected as candidate SPS or candidate DPS (i.e. the candidate SPSs) according to the amplitude information.

In a specific implementation, this embodiment may first exclude the SPS that has been detected in the preset region growth network, and then set a reasonable average amplitude threshold (that is, the amplitude threshold) to screen the remaining SPSs to remove most invalid pixels that belong to water or shadow areas. The candidate PSs can then be connected to the SPSs in the preset region growth network of the first layer that are closest and within the distance threshold to build arcs, forming a local star network.

Step S40: detecting a target remaining SPS and all DPSs in the target region through the local star network, so as to perform five-dimensional imaging on the target region based on the reliable SPS, the target remaining SPS and all the DPSs.

It should be noted that the target remaining SPS may be remaining in the target region other than the SPS that has been detected by the preset region growth network, and is a SPS within the distance threshold.

It should be understood that, after the local star network is formed, the influence of the APS can be eliminated by using the interference phase difference between the two points in the local star network. After the APS is calibrated, whether the point in the local star network is a reliable DPS or SPS may be detected using a beam forming-based self-supervised graph learning real-time communication (SGLRTC) algorithm to detect the remaining SPS and all DPSs in the target region.

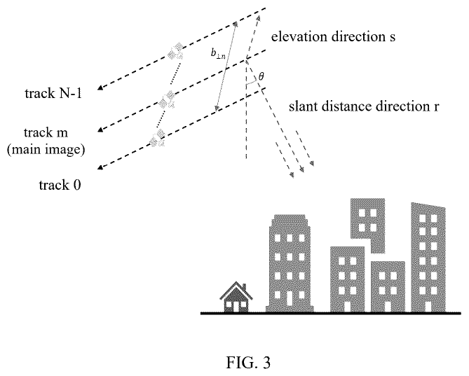

It may be understood that the SAR chromatography technology may use a multi-baseline sensor to measure the same region at different angles, so as to form a synthetic aperture upward in a third three-dimensional elevation in addition to a distance and azimuth direction, thereby achieving a real three-dimensional imaging effect. However, with the development of the SAR satellite system, the SAR satellite system with higher frequency band is more sensitive to subtle changes, such as deformation caused by thermal expansion, and the scattering intensity of the scatterer in the same azimuth-distance pixel in elevation, linear deformation and thermal expansion coefficient can be solved, which is referred to as five-dimensional SAR chromatography, that is, the five-dimensional imaging effect of the region can be achieved. In practical applications, as shown in FIG. 3, FIG. 3 is a principle schematic diagram of SAR tomography in the regional five-dimensional imaging method according to an embodiment of the present application. Since the SAR chromatography technology uses a multi-baseline sensor to measure the same region and at different angles (only slightly different), a signal from two or more scattering elements may be received by an array composed of N sensors in FIG. 3. A plurality of tracks such as a track 0, a track M (a main track) and a track N−1 are included in the figure. After necessary phase correction is performed on the data set (for example, compensation for the phase generated by long-time deformation or atmospheric propagation effect, etc.), the received signal gₙ of each azimuth-range pixel may be expressed as the contribution superposition of the backward scattering intensity γ along the elevation s (The conversion relationship between elevation s, vertical height h, and incident angle θ is h=s·sin(θ)), the linear deformation rate v, and all elements of the thermal expansion coefficient k, and the calculation formula is as follows:

$${g}_{n} = \int \int {\int }_{Δ {s}^{′} Δ {v}^{′} Δ k} γ ( s , v , k ) {e}^{- j 2 π ( {ξ}_{n} s + {η}_{n} v + {ς}_{n} k )} dsdvdk$$

Δₛ is the range of the scene elevation direction, ξₙ=2b_{⊥n}/λr is the spatial frequency, ηₙ=2tₙ/λ is the time frequency, ζₙ=2Tₙ/2 is the thermal frequency, b_{⊥n} is the spatial vertical baseline relative to the main image, tₙ is the time baseline, Tₙ is the thermal baseline, λ is the operating wavelength, and r is the pitch. The formula shows that the scattering intensity γ(s, v, k) of the scatterer in the same azimuth-distance pixel can be solved at the elevation s, the linear deformation rate v and the thermal coefficient k domain by using the three-dimensional Fourier transform.

In urban applications, the general scattering process has a main scattering characteristic and a “overlay” effect, and it can be considered that the backward scattering intensity γ is composed of a finite number of δ-Dirac functions with different scattering phase centers. If the γ is reconstructed, a single or multiple “overlay” targets may be located by looking for the peaks of γ. Taking into account the noise that may exist in actual situations, and discretizing the above calculation formula by M=Mₛ×Mᵥ×Mₖ point in three directions, it can be rewritten as the following linear problem with noise, and its calculation formula is as follows:

$$g = L γ + e$$

g=[g₀, . . . , g_{N-1}] is a received complex signal vector of each pixel, γ=γ(s, v, k) is a back scattering distribution of a scatterer in the same azimuth-distance pixel at an elevation s, a linear deformation speed v, and a thermal expansion coefficient k domain. L=[ [symbol] (s₀, v₀, k₀), . . . , [symbol] (s_{M}_{ₛ}₋₁, v_{M}_{ᵥ}₋₁, k_{M}_{ₖ}₋₁)] is a system steering matrix of order N×M, and the mapping between the model space and the data space is implemented. In the five-dimensional imaging, the steering vector of the system matrix Lis related to three parameters

$$( {s}_{p} , {y}_{q} , {k}_{l} ) . \\ ℓ ( {s}_{p} , {y}_{q} , {k}_{l} ) = exp [ - j 2 π ( ξ {s}_{p} + η {v}_{q} + ϛ {k}_{l} ) ] , \\ ξ = {[ {ξ}_{0} , … , {ξ}_{N - 1} ]}^{T} , \\ η = {[ {η}_{0} , … , {η}_{N - 1} ]}^{T} , S = {[ {ϛ}_{0} , … , {ϛ}_{N - 1} ]}^{T} .$$

e is a N-dimensional noise vector.

In this embodiment, the three geophysical parameters such as elevation, linear deformation rate and thermal expansion coefficient may be obtained by using persistent scatterer interferometric synthetic aperture radar (PSInSAR) or tomographic synthetic aperture radar (TomoSAR). The PSInSAR may assume that each pixel contains at most one persistent scatterer, that is, the reconstructed γ has at most one effective value. If there is one persistent scatterer in the pixel, the phase of gₙ can be directly represented. φₙ represents the phase unwrapping of gₙ, which is mainly composed of four contributions, and the calculation formula is as follows:

$${φ}_{n} = ( {φ}_{ele} ) + ( {φ}_{def} ) + ( {φ}_{APS} ) + ( {φ}_{noise} )$$

Wherein φₑₗₑ is the elevation phase contribution, φ_{def} is a deformation phase contribution, φ_{APS} is an APS phase contribution, and φₙₒᵢₛₑ the decorrelation noise phase contribution. φₑₗₑ and φ_{def} can be mathematically modeled using relevant baseline data as follows:

$${( {φ}_{ele} )}_{n} = 2 π {ξ}_{n} s \\ ( {φ}_{def} ) = 2 π ( {η}_{n} v + {ϛ}_{n} k )$$

The elevation, linear deformation speed, and thermal amplitude are three geophysical parameters that need to be estimated. For PS, the decorrelated noise is typically very small. Thus, if APS is removed, these three geophysical parameters can be estimated.

The TomoSAR may assume that there may be a plurality of PSs in one pixel, that is, the reconstructed γ may contain a plurality of valid values. In this case, the phase of gₙ cannot be processed directly because the pixels may collect the phases of multiple PSs. To determine how many PSs are present in one pixel, the fault scan Y must first be reconstructed as follows:

$$\hat{γ} ( s , v , k ) = \frac{\vert {a ( s , v , k )}^{H} g \vert}{{‖ a ( s , v , k ) ‖}_{2} {‖ g ‖}_{2}}$$

∥•∥₂ is a 2 norm. By identifying the peaks in the normalized tomogram magnitude (NTM), how many PS interfering pixels can be determined. Beam forming is the simplest way to reconstruct a tomographic scan. If maximum NTM, i.e. max(\hat{γ}) is greater than a given threshold (typically 0.75), the pixel is considered to be SPS, and the corresponding geophysical parameter may be extracted.

In a specific implementation, after detecting the remaining SPS and all DPSs in the target region, the relative parameters of the target remaining SPS may be determined by using an M estimator (an estimator with a relatively high estimation precision). All the above-mentioned DPSs can be estimated by the beam forming method, and the spatial estimation results can be obtained according to the corresponding positions of their peak values. After the relative parameters are obtained, the absolute parameter of the reliable SPS in the preset region growth network of the first layer is obtained to obtain three geophysical parameters (i.e. elevation, linear deformation rate and thermal expansion coefficient) of the whole region network, so as to realize the five-dimensional imaging of the target region.

This embodiment discloses the following steps: preprocessing target interference measurement data and obtaining processed differential interference data; detecting, based on the differential interference data, through a preset region growth network, reliable SPS in a target region corresponding to the target interference measurement data; constructing, based on all SPSs in the preset region growth network, a local star network; and detecting, through the local star network, target remaining SPS and all DPSs in the target region, and performing, based on the reliable SPS, the target remaining SPS and all the DPSs, five-dimensional imaging on the target region. In this embodiment, the reliable SPS in the target region is detected through the preset region growth network, the local star network is constructed based on all the SPSs in the preset region growth network to detect the target remaining SPS and all the DPSs in the target region, and finally, five-dimensional imaging of the target area is performed based on the reliable SPS, the target remaining SPS and all the DPSs, so that the technical problem that the area imaging quality is affected due to the fact that the network applied to area imaging in SAR tomography cannot cover the whole research area in the related art is solved.

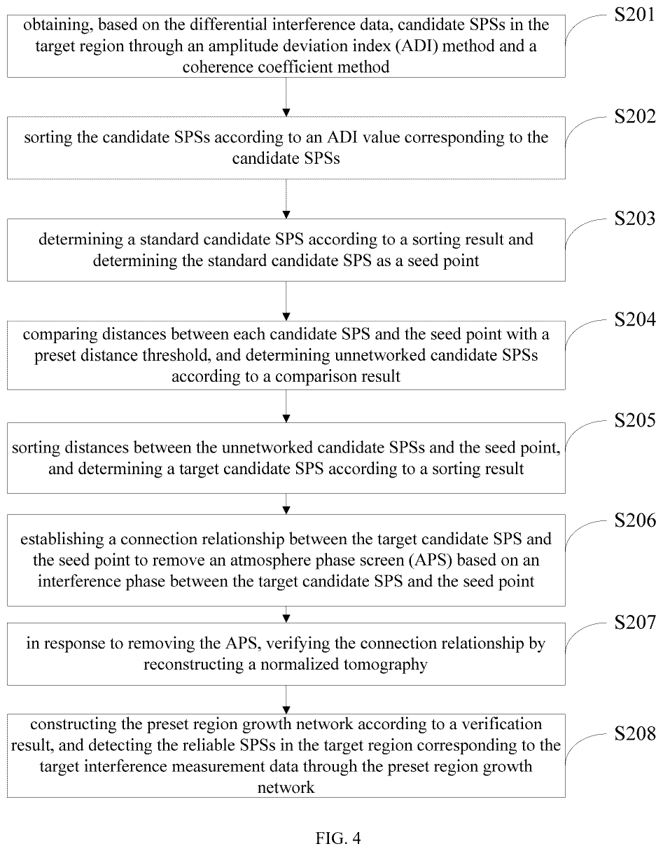

As shown in FIG. 4, FIG. 4 is a schematic flowchart of a regional five-dimensional imaging method according to another embodiment of the present application.

Based on the above embodiment, in this embodiment, the step S20 includes:

Step S201: obtaining, based on the differential interference data, a candidate SPS in the target region through an ADI method and a coherence coefficient method.

It should be noted that the ADI threshold method may be a method for selecting a SPS in a certain area by using the amplitude dispersion of the same pixel in the time sequence, and the formula corresponding to the selected SPS is:

$${D}_{A} = \frac{{σ}_{A}}{{m}_{A}}$$

D_{A} is an ADI, σ_{A} is an amplitude standard deviation, and m_{A} is an amplitude mean value.

In practical applications, the ADI threshold may be set to 0.25. When the ADI is less than 0.25, it indicates that the phase standard deviation and the amplitude dispersion index are approximately equal, and therefore, the ADI may be used as a measurement parameter of phase stability.

It should be understood that the coherence coefficient threshold method involves selecting an appropriate coherence coefficient threshold based on the average coherence coefficients derived from multiple interferograms, pixels with coherence coefficient values exceeding this threshold are identified as phase-stable point, and a formula corresponding to the point with stable phase is selected as:

$$\frac{1}{N} {\sum }_{i = 0}^{N - 1} {γ}_{i} \geq {γ}_{T}$$

γᵢ is the coherence coefficient of a single pixel in the ith interferogram, and γ_{T} is the coherence coefficient threshold.

When the threshold is set, the threshold may be properly improved compared with the usually set threshold, so that the screened candidate SPS can be ensured to be reliable SPS as much as possible, and on the other hand, the calculation amount of the preset region growth network can be reduced.

It may be understood that the candidate SPS may be a PS in the target region that may be the reliable SPS.

Step S202: sorting the candidate SPSs according to the ADI corresponding to the candidate SPSs.

It should be noted that, after the ADI of each candidate SPS is calculated through the ADI threshold method, the candidate SPSs may be sorted from small to large according to the ADI.

Step S203: determine a standard candidate SPS according to the sorting result, and determine the standard candidate SPS as a seed point.

It should be understood that, since the candidate SPS with the smallest ADI is most likely to be a reliable SPS, this embodiment may determine the candidate SPS with the smallest ADI as the standard candidate SPS, and select the standard candidate SPS as the seed point for growth.

Step S204: the distance between each candidate SPS and the seed point is compared with a preset distance threshold, and the unnetworked candidate SPS is determined according to the comparison result.

It may be understood that the preset distance threshold may be a distance threshold between the candidate SPS and the seed point. In practical applications, since the APS phases are close to each other only when the distances between the SPSs are close, and the influence of the APS can be eliminated by using the interference phase between the two points, so that the reasonable distance threshold can be set according to the size of the research area, so as to retrieve the unnetworked candidate SPS whose distances from the seed point are within the threshold and have not been added to the network.

Step S205: sorting a distance between the unnetworked candidate SPS and the seed point, and determining a target candidate SPS according to the sorting result.

It should be noted that the target candidate SPS may be an unnetworked candidate SPS that has a closest distance to the seed point. In practical applications, in this embodiment, the unnetworked candidate SPSs located within the distance threshold of the seed point may be sorted according to the distance between the unnetworked candidate SPS and the seed point, so as to preferentially consider points that are closer to each other, and determine the point closest to the distance as the target candidate SPS.

Step S206: establishing a connection relationship between the target candidate SPS and the seed point to remove the APS based on an interference phase between the target candidate SPS and the seed point.

It should be understood that, after the target candidate SPS is determined, the connection relationship between the target candidate SPS and the seed point may be established, and the influence of the APS may be eliminated by using the interference phase difference between the target candidate SPS and the seed point.

Step S207: when the APS is removed, verifying the connection relationship by reconstructing a normalized tomography.

Step S208: constructing a preset region growth network according to the verification result, and detecting a reliable SPS in the target region corresponding to the target interference measurement data through the preset region growth network.

It may be understood that the step of constructing a preset region growth network according to the verification result may specifically include: if the detected maximum scan value exceeds a preset scan threshold, determining the connection relationship as a connection arc between reliable SPSs in a target region corresponding to the target interference measurement data; and adding the target candidate SPS to a reference network based on the connection arc to construct a preset region growth network based on the reference network.

It should be noted that this embodiment may verify the connection between the target candidate SPS and the seed point by reconstructing the normalized tomography. If the maximum value of the tomography is greater than a given threshold, it is considered that the connection is an arc connected between the reliable SPS, that is, both the seed point and the target candidate SPS are SPS, and the point is incorporated into the preset region growth network. If the maximum value of the tomography is smaller than the threshold, the point is skipped, and the next point sorted according to the distance continues to be verified.

Further, in order to facilitate data access during network growth, after the step of adding the target candidate SPS to the reference network based on the connection arc, the method further includes: storing the target candidate SPS into a to-be-grown node queue; When the number of candidate SPSs connected to the seed point exceeds a sub-node quantity threshold, or a candidate SPS verification whose distance from the seed point does not exceed the preset distance threshold is completed, a queue head element of the to-be-grown node queue is determined as a new seed point; returning to the step of comparing the distance between each candidate SPS and the seed point with a preset distance threshold, and determining the unnetworked candidate SPS according to the comparison result, until the to-be-grown node queue is empty.

It should be understood that, in order to avoid network redundancy, improve calculation speed and ensure calculation accuracy, it is necessary to set the maximum upper limit Y of the number of sub-nodes (that is, the above-mentioned sub-node quantity threshold), that is, when each candidate SPS grows outwards as the growth node, it establishes reliable connections with at most Y candidate SPSs. The sub-node quantity threshold may be set according to specific requirements, which is not limited in this embodiment.

It may be understood that, after the reliable SPS arc is obtained through verification, a relative parameter between the two SPS points needs to be calculated. After phase unwrapping, the inversion problem can be reformulated using the unwrapped phase Δφ as follows:

$$Δφ = DJ$$

$$φ = {[ {Δφ}_{0} , … , {Δφ}_{N - 1} ]}^{T}$$

$$D = {[ \begin{matrix}2 π {ξ}_{0} & 2 π {η}_{0} & 2 {πϛ}_{0} \\ ⋮ & ⋮ & ⋮ \\ 2 π {ξ}_{N - 1} & 2 π {η}_{N - 1} & 2 {πϛ}_{N - 1}\end{matrix} ]}_{N \times 3}$$

$$J = {[ \begin{matrix}s & v & k\end{matrix} ]}^{T}$$

In practice, to mitigate the impact of possible phase outliers, which may contain anomalies due to low-quality images or unwrapping errors, a robust M-estimator can be used to estimate the relative parameters.

The iteration count is set to 1=0, and the initial weight matrix W is the unit matrix I, as follows:

$${W}^{( l = 0 )} = {I}_{M}$$

The weighted least squares estimate is solved as follows:

$${\hat{J}}^{( l )} = {( {D}^{T} {W}^{( l )} D )}^{( - 1 )} {D}^{T} {W}^{( l )} Δφ$$

The remaining phase

$${r}^{( l )} = Δ φ - D {\hat{J}}^{( l )}$$

$${W}_{i}^{( l + 1 )} = \{ \begin{matrix}1 , & for \vert {r}_{i}^{( 1 )} \vert \leq {C}_{M - estimator} \\ \frac{{C}_{M - estimator}}{\vert {r}_{i}^{( 1 )} \vert} , & for \vert {r}_{i}^{( 1 )} \vert > {C}_{M - estimator}\end{matrix}$$

and the associated weight

$${W}^{( l + 1 )} = diag \{ {w}_{i}^{( l + 1 )} \}$$

are calculated as follows:

$${{r}^{{( l )}_{=}} [ {r}_{0}^{( l )} , … , {r}_{N - 1}^{( l )} ]}^{T}$$

C_{M-estimator} may generally be set to 1.345.

Terminate when convergence occurs; otherwise set l=l+1 and return to the step of solving the weighted least squares estimate.

In this process, the M estimator iteratively reassigns a smaller weight to the larger remaining phase, and therefore, the estimate is not susceptible to the phase outlier. Finally, the relative parameter obtained by the M estimator can be multiplied by the overall coherence at the arc (here the maximum NTM) as a weight factor to obtain the final relative parameter.

It should be noted that, when the number of sub-nodes of the seed point reaches a set sub-node quantity threshold, or all candidate SPSs that are within the preset distance threshold of the seed point and have not yet joined the network are verified, it indicates that the growth process of the seed point has ended, and at this time, a new growth node needs to be replaced to perform network growth of the next round. Therefore, it is necessary to pop out the head element of the to-be-grown node queue as a new round of growth nodes, and return to the step of comparing the distance between each candidate SPS and the seed point with the preset distance threshold, and determining the unnetworked candidate SPS based on the comparison result, until no new candidate SPS joins the network, that is, the to-be-grown node queue is empty.

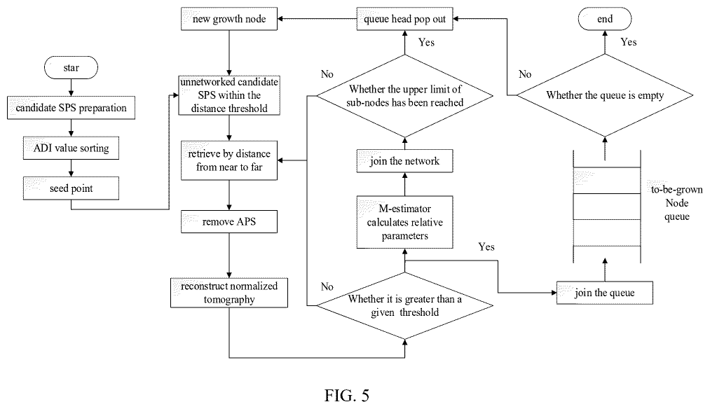

In a specific implementation, in this embodiment, a preset region growth network may be constructed by using a region growth network algorithm, and with reference to FIG. 5, FIG. 5 is a schematic flowchart of a region growth algorithm in the regional five-dimensional imaging method according to another embodiment of the present application. As shown in FIG. 5, firstly, a candidate SPS in a target region can be obtained, and candidate SPSs are sorted according to the ADI corresponding to the candidate SPS to determine the candidate SPS with the smallest ADI value as a seed point. Then the candidate SPS located within the seed point distance threshold and not added into the network are retrieved from near to far according to the distance between the candidate SPS and the seed point, and the candidate SPS closest to the seed point is connected to the seed point. The APS was removed by interferometric phase calculation and the connection was then verified by reconstructing normalized tomograms. If the maximum value of the tomography is greater than a given threshold, it is considered that the connection is an arc connected between the reliable SPS, that is, both the seed point and the target candidate SPS are SPS, and the point is incorporated into the preset region growth network. If the maximum value of the tomography is smaller than the threshold, the point is skipped, and the next point sorted according to the distance continues to be verified. When the number of sub-nodes of the seed point reaches the upper limit of the sub-node, or the candidate SPS that is within the point distance threshold and has not been added to the network is completely retrieved, the head element of the to-be-grown node queue can be popped out as the growth node of the new wheel for growth until the to-be-grown node queue is empty.

Further, in the entire growth process, the node that has joined the network will no longer act as a sub-node of the subsequent growth node. In the foregoing manner, a reference network may be obtained, each node of the reference network has only one parent-node, and there are at most Y sub-nodes, which means that the circulation of the relative parameters in the entire network is unidirectional, and no loop is generated. Meanwhile, in the network growth process, the relative parameters of the SPS arc, that is, the relative parameters of the parent-node and the sub-node of each connection arc, have been calculated through the M estimator. Therefore, only the absolute parameter of any node in the network needs to be known, and the only determined absolute parameter of all the SPSs in the whole network can be obtained. However, in actual processing, a network is often insufficient to cover the entire research area. Therefore, it is necessary to evaluate whether the obtained SPS network can cover the entire area. Therefore, after the step of adding the target candidate SPS to the reference network based on the connection arc to construct the preset region growth network based on the reference network, the method further includes: obtaining the number of scatterers of the remaining candidate SPSs that are not in the preset region growth network, and the total number of scatterers of all the candidate SPSs in the target region; determining a coverage indicator value of the target region based on the number of scatterers and the total number of scatterers; comparing the coverage indicator value with a preset coverage indicator threshold; and when the coverage indicator value does not exceed the coverage indicator threshold, constructing a new preset region growth network based on the remaining candidate SPSs.

It may be understood that, when candidate SPS screening is performed, the screening condition is more strict, and therefore, it may be considered that the candidate SPS is basically a candidate SPS. Therefore, it is possible to use the ratio of the number of candidate SPS remaining outside the reference network to all candidate SPS as an index for measuring whether the SPS network obtained by the region growth algorithm covers the entire research region, as follows:

$${N}_{ra} = \frac{{N}_{re}}{{N}_{CSPS}} \times 100 \%$$

Nᵣₑ is the number of remaining candidate SPS (i.e., the number of scatterers above), N_{CSPS} is the number of all candidate SPSs screened by the preset region growth network of the first layer (i.e., the total number of scatterers above), and Nᵣₐ is the coverage indicator value of the target region.

In general, the preset coverage indicator threshold Nₜₕ may be set to 30%. When the actual ratio is greater than the proportion threshold, it is considered that the current SPS network has a considerable part of omission, that is, the extracted building structure information is not fully explored and utilized. Therefore, the remaining candidate SPS needs to be reordered, and a new SPS network continues to be built according to the foregoing region growth algorithm until the proportion of the remaining candidate SPS is lower than a specified proportion threshold.

Further, in order to improve the efficiency of geophysical parameter extraction, after the step of constructing a new preset region growth network based on the remaining candidate SPSs when the coverage indicator value does not exceed the coverage indicator threshold, the method further includes: when the number of the preset region growth networks exceeds a preset network quantity threshold, obtaining a target candidate SPS pair between the preset region growth networks; sorting the distances between the target candidate SPS pairs, and verifying the target candidate SPS pair according to a sorting result; and determining whether the target candidate SPS pair belongs to the reliable SPS according to an verification result.

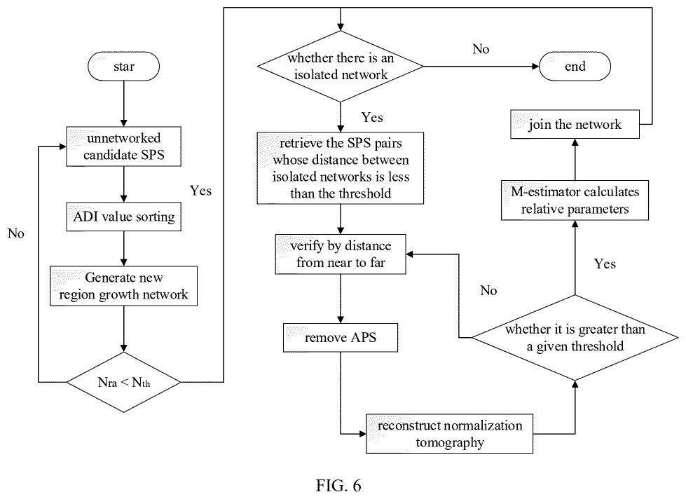

In a specific implementation, in urban environments with relatively dense buildings, generally 1-3 sub-networks may cover the entire research area. However, there are a plurality of disconnected isolation networks, which means that reference points need to be found in each network, which is not conducive to the high efficiency of physical parameter extraction. Therefore, when there are two or three isolation networks, that is, when the number of preset region growth networks exceeds a preset network quantity threshold, in order to further construct the maximum connection network, it is necessary to attempt to establish a connection between several networks. As shown in FIG. 6, FIG. 6 is a schematic flowchart of establishing a maximum connected network in the regional five-dimensional imaging method according to another embodiment of the present application. After the new preset region growth network is generated, if the coverage index value Nᵣₐ is less than the coverage index threshold Nₜₕ, it indicates that an isolated network exists. Because there is an upper limit on the number of sub-nodes in the growth network, there may be situations in which arcs between SPS points in the two isolation networks are reliable SPS arcs. Therefore, firstly, an SPS pair that is less than a distance threshold between two preset region growth networks needs to be retrieved, where the distance threshold is the same as the distance threshold of constructing region growth network. Then, the distances are sorted from small to large, and APS is removed. Then whether it is a reliable SPS arc is verified by reconstructing the normalized tomography, until the connection passing the verification is found, and meanwhile, the relative parameters at the arc are calculated. Through the connection between the SPS pair, the two isolation networks can be combined into a larger reference network, and the absolute parameters are correspondingly obtained.

According to the embodiment, the seed point is determined according to the ADI corresponding to the candidate SPS in the target region, the unnetworked candidate SPS is determined according to the distance between each candidate SPS and the seed point. Then a connection relationship is established between the target candidate SPS determined according to the distance between the unnetworked candidate SPS and the seed point and the seed point to remove the APS. A preset region growing network is constructed based on the verification result of the connection relationship of the reconstructed normalized tomography, and reliable SPSs in the target area are verified. No loop is generated in the whole network growth process, thereby reducing the time and difficulty of data processing.

In addition, an embodiment of the present application further provides a storage medium, where the storage medium stores a regional five-dimensional imaging program, and when the regional five-dimensional imaging program is executed by a processor, the steps of the regional five-dimensional imaging method as described above are implemented.

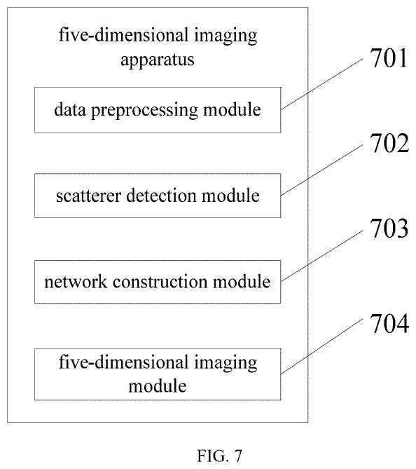

As shown in FIG. 7, FIG. 7 is a structural block diagram of a regional five-dimensional imaging apparatus according to an embodiment of the present application.

A regional five-dimensional imaging apparatus according to an embodiment of the present application includes a data preprocessing module 701, a scatterer detection module 702, a network construction module 703, and a five-dimensional imaging module 704.

The data preprocessing module 701 is configured to pre-process the target interference measurement data to obtain processed differential interference data.

The scatterer detection module 702 is configured to detect, based on the differential interference data, a reliable SPS in a target region corresponding to the target interference measurement data through a preset region growth network.

The network construction module 703 is configured to construct a local star network based on all SPSs in the preset region growth network.

The five-dimensional imaging module 704 is configured to detect a target remaining SPS and all DPSs in the target region through the local star network, to perform five-dimensional imaging on the target region based on the reliable SPS, the target remaining SPS, and all the DPSs.

Further, the network construction module 703 is further configured to obtain remaining SPSs based on all SPSs in the preset region growth network, screen the remaining SPSs through an amplitude threshold to obtain candidate PSs, and construct a local star network based on the candidate PSs.

The regional five-dimensional imaging apparatus of this embodiment discloses the following steps: preprocessing target interference measurement data and obtaining processed differential interference data; detecting, based on the differential interference data, through a preset region growth network, reliable SPS in a target region corresponding to the target interference measurement data; constructing, based on all SPSs in the preset region growth network, a local star network; and detecting, through the local star network, target remaining SPS and all DPSs in the target region, and performing, based on the reliable SPS, the target remaining SPS and all the DPSs, five-dimensional imaging on the target region. In this embodiment, the reliable SPS in the target region is detected through the preset region growth network, the local star network is constructed based on all the SPSs in the preset region growth network to detect the target remaining SPS and all the DPSs in the target region, and finally, five-dimensional imaging of the target area is performed based on the reliable SPS, the target remaining SPS and all the DPSs, so that the technical problem that the area imaging quality is affected due to the fact that the network applied to area imaging in SAR tomography cannot cover the whole research area in the related art is solved.

Based on the above-mentioned embodiment of the regional five-dimensional imaging apparatus of the present application, another embodiment of the regional five-dimensional imaging apparatus of the present application is proposed.

In this embodiment, the scatterer detection module 702 is further configured to obtain, based on the differential interference data, candidate SPSs in the target region through an ADI method and a coherence coefficient method; sort the candidate SPSs according to an ADI value corresponding to the candidate SPSs; determine a standard candidate SPS according to a sorting result, and determine the standard candidate SPS as a seed point; compare the distances between each candidate SPS and the seed point with a preset distance threshold, and determine, the unnetworked candidate SPSs according to a comparison result; sort the distances between the unnetworked candidate SPSs and the seed point, and determine a target candidate SPS according to a sorting result; establish a connection relationship between the target candidate SPS and the seed point to remove an APS based on an interference phase between the target candidate SPS and the seed point; verify the connection relationship by reconstructing a normalized tomography, when the APS is removed; and construct the preset region growth network according to the verification result, and detect the reliable SPSs in the target region corresponding to the target interference measurement data through the preset region growth network.

Further, the scatterer detection module 702 is further configured to if the detected maximum scan value exceeds a preset scan threshold, determine the connection relationship as a connection arc between the reliable SPSs in the target region corresponding to the target interference measurement data; and add the target candidate SPS to a reference network based on the connection arc, so as to construct the preset region growth network based on the reference network.

Further, the scatterer detection module is further configured to store the target candidate SPS into a to-be-grown node queue; when a number of candidate SPSs connected to the seed point exceeds a sub-node quantity threshold, or the verification of candidate SPSs within the preset distance threshold from the seed point is completed, determine a queue head element of the to-be-grown node queue as new seed point; and return to the step of comparing distances between each candidate SPS and the seed point with the preset distance threshold, and determine unnetworked candidate SPSs according to the comparison result, until the to-be-grown node queue is empty.

Further, the scatterer detection module is further configured to obtain a number of scatterers for remaining candidate SPSs outside the preset region growth network, and a total number of scatterers for all the candidate SPSs in the target region; determine a coverage indicator value of the target region based on the number of scatterers and the total number of scatterers; compare the coverage indicator value with a preset coverage indicator threshold; and when the coverage indicator value does not exceed the coverage indicator threshold, construct the new preset region growth network based on the remaining candidate SPSs.

Further, the scatterer detection module is further configured to when a number of the preset region growth networks exceeds a preset network quantity threshold, obtain target candidate SPS pairs between the preset region growth networks; sort the distances between the target candidate SPS pairs, and verify the target candidate SPS pairs according to a sorting result; and according to a verification result, determine whether the target candidate SPS pairs belong to the reliable SPSs.

According to the embodiment, the seed point is determined according to the ADI corresponding to the candidate SPS in the target region, the unnetworked candidate SPS is determined according to the distance between each candidate SPS and the seed point. Then a connection relationship is established between the target candidate SPS determined according to the distance between the unnetworked candidate SPS and the seed point and the seed point to remove the APS. A preset region growing network is constructed based on the verification result of the connection relationship of the reconstructed normalized tomography, and reliable SPSs in the target area are verified. No loop is generated in the whole network growth process, thereby reducing the time and difficulty of data processing.

It should be noted that, in this specification, the terms “include”, “involve”, or any other variant thereof are intended to cover non-exclusive inclusion, so that a process, method, article, or system that includes a series of elements includes not only those elements, but also other elements that are not explicitly listed, or elements inherent to the process, method, article, or system. In the absence of more restrictions, the elements defined by the phrase “include a . . . ” do not exclude the existence of other identical elements in the process, method, article or system including the element.

The sequence numbers of the foregoing embodiments of the present application are merely for description, and do not represent the advantages and disadvantages of the embodiments.

Through the description of the foregoing implementations, persons skilled in the art may clearly understand that the method in the foregoing embodiments may be implemented by means of software plus a necessary general hardware platform, and certainly may also be implemented by hardware, but in many cases, the former is a better implementation. Based on this understanding, the technical solution of the present application essentially or the part contributing to the related art may be embodied in the form of a software product, and the computer software product is stored in a storage medium (for example, a read-only memory/random access memory, a magnetic disk, and an optical disk), and includes several instructions for enabling a terminal device (which may be a mobile phone, a computer, a server, a network device, or the like) to perform the method according to the embodiments of the present application.

The above are merely embodiments of the present application, and are not therefore intended to limit the patent scope of the present application, and any equivalent structure or equivalent process transformation made by using the description and drawings of the present application, or directly or indirectly used in other related technical fields, are all included in the scope of the present application.

What is claimed is:

1. A regional five-dimensional imaging method, comprising:
preprocessing target interference measurement data to obtain processed differential interference data;
detecting, based on the differential interference data, reliable single permanent scatterers (SPSs) in a target region corresponding to the target interference measurement data through a preset region growth network;
constructing a local star network based on all SPSs in the preset region growth network; and
detecting, through the local star network, a target remaining SPS and all double permanent scatterers (DPSs) in the target region, to perform five-dimensional imaging on the target region based on the reliable SPSs, the target remaining SPS and all the DPSs.

2. The regional five-dimensional imaging method according to claim 1, wherein the detecting, based on the differential interference data, reliable single permanent scatterers (SPSs) in the target region corresponding to the target interference measurement data through the preset region growth network comprises:
obtaining, based on the differential interference data, candidate SPSs in the target region through an amplitude deviation index (ADI) method and a coherence coefficient method;
sorting the candidate SPSs according to an ADI value corresponding to the candidate SPSs;
determining a standard candidate SPS according to a sorting result and determining the standard candidate SPS as a seed point;
comparing distances between each candidate SPS and the seed point with a preset distance threshold, and determining unnetworked candidate SPSs according to a comparison result;
sorting distances between the unnetworked candidate SPSs and the seed point, and determining a target candidate SPS according to a sorting result;
establishing a connection relationship between the target candidate SPS and the seed point to remove an atmosphere phase screen (APS) based on an interference phase between the target candidate SPS and the seed point;
in response to removing the APS, verifying the connection relationship by reconstructing a normalized tomography; and
constructing the preset region growth network according to a verification result, and detecting the reliable SPSs in the target region corresponding to the target interference measurement data through the preset region growth network.

3. The regional five-dimensional imaging method according to claim 2, wherein the sorting the candidate SPSs according to the ADI value corresponding to the candidate SPSs comprises:
sorting the candidate SPSs from small to large according to the ADI value.

4. The regional five-dimensional imaging method according to claim 2, wherein the constructing the preset region growth network according to the verification result comprises:
in response to that a maximum scan value of the verification exceeds a preset scan threshold, determining the connection relationship as a connection arc between the reliable SPSs in the target region corresponding to the target interference measurement data; and
adding the target candidate SPS to a reference network based on the connection arc to construct the preset region growth network based on the reference network.

5. The regional five-dimensional imaging method according to claim 4, wherein the constructing the preset region growth network according to the verification result further comprises:
in response to that the maximum scan value of the verification is less than the preset scan threshold, skipping the current target candidate SPS, and continuing to verify the next unnetworked candidate SPS sorted according to the distance.

6. The regional five-dimensional imaging method according to claim 4, wherein after the adding the target candidate SPS to the reference network based on the connection arc, the method further comprises:
storing the target candidate SPS into a to-be-grown node queue;
in response to that a number of candidate SPSs connected to the seed point exceeds a sub-node quantity threshold, or the verification of candidate SPSs within the preset distance threshold from the seed point is completed, determining a queue head element of the to-be-grown node queue as new seed point; and
returning to the step of comparing distances between each candidate SPS and the seed point with the preset distance threshold, and determining unnetworked candidate SPS according to the comparison result until the to-be-grown node queue is empty.

7. The regional five-dimensional imaging method according to claim 4, wherein after the adding the target candidate SPS to the reference network based on the connection arc to construct the preset region growth network based on the reference network, the method further comprises:
obtaining a number of scatterers for remaining candidate SPSs outside the preset region growth network, and a total number of scatterers for all the candidate SPSs in the target region;
determining a coverage indicator value of the target region based on the number of scatterers and the total number of scatterers;
comparing the coverage indicator value with a preset coverage indicator threshold; and
in response to that the coverage indicator value does not exceed the coverage indicator threshold, constructing the new preset region growth network based on the remaining candidate SPSs.

8. The regional five-dimensional imaging method according to claim 7, wherein after the in response to that the coverage indicator value does not exceed the coverage indicator threshold, constructing the new preset region growth network based on the remaining candidate SPSs, the method further comprises:
in response to that a number of the preset region growth networks exceeds a preset network quantity threshold, obtaining target candidate SPS pairs between the preset region growth networks;
sorting the distances between the target candidate SPS pairs, and verifying the target candidate SPS pairs according to a sorting result; and
determining whether the target candidate SPS pairs belong to the reliable SPSs according to a verification result.

9. The regional five-dimensional imaging method according to claim 2, wherein the constructing the preset region growth network according to the verification result comprises:
obtaining the candidate SPSs in the target region, and sorting the candidate SPSs according to the ADI value corresponding to the candidate SPSs;
determining the candidate SPS with the smallest ADI value as the seed point, and retrieving the unnetworked candidate SPSs located within the a distance threshold of seed point from near and far according to the distance between the candidate SPSs and the seed point;
establishing the connection relationship between the candidate SPS closest to the seed point and the seed point, and removing the APS through interference phase calculation;
verifying the connection relationship by reconstructing the normalized tomography;
in response to that a maximum value of the normalized tomography is greater than a given threshold, determining that the connection relationship is a connection arc between the reliable SPSs, wherein the seed point and the current candidate SPS are both SPSs;
incorporating the current candidate SPS into a reference network, and adding nodes in each newly joining network into a to-be-grown node queue; and
in response to that a maximum value of the normalized tomography is smaller than the given threshold, skipping the current candidate SPS, and continuing to verify the next candidate SPS sorted according to the distance.

10. The regional five-dimensional imaging method according to claim 9, wherein the constructing the preset region growth network according to the verification result further comprises:
in response to that a number of sub-nodes of the seed point reaches an upper limit of the sub-node, or all the unnetworked candidate SPSs located within the distance threshold of the current seed point are completely retrieved, popping up a queue head element of the to-be-grown node queue as a growth node of the new wheel for growth until the to-be-grown node queue is empty.

11. The regional five-dimensional imaging method according to claim 1, wherein the constructing the local star network based on all SPSs in the preset region growth network comprises:
obtaining remaining SPSs based on all the SPSs in the preset region growth network;
screening the remaining SPSs through an amplitude threshold, and obtaining candidate permanent scatterers (PSs); and
constructing the local star network based on the candidate PSs.

12. The regional five-dimensional imaging method according to claim 2, wherein:
the differential interference data is data obtained after amplitude calibration and differential interference are performed on the target interference measurement data;
the preset distance threshold is a distance threshold between the candidate SPS and the seed point; and
the target remaining SPS is the SPS remaining in the target region except the SPSs detected by the preset region growth network and within the distance threshold.

13. A regional five-dimensional imaging device, comprising:
a regional five-dimensional imaging apparatus;
a memory;
a processor; and
a regional five-dimensional imaging program stored on the memory and executable on the processor, wherein the regional five-dimensional imaging program is configured to implement the regional five-dimensional imaging method according to claim 1.

14. The regional five-dimensional imaging device according to claim 13, wherein the regional five-dimensional imaging apparatus comprises:
a data preprocessing module, configured to pre-process target interference measurement data to obtain processed differential interference data;
a scatterer detection module, configured to detect, based on the differential interference data, reliable SPSs in a target region corresponding to the target interference measurement data through a preset region growth network;
a network construction module, configured to construct a local star network based on all SPSs in the preset region growth network; and
a five-dimensional imaging module, configured to detect target remaining SPSs and all DPSs in the target region through the local star network to perform five-dimensional imaging on the target region based on the reliable SPSs, the target remaining SPSs and all the DPSs.

15. The regional five-dimensional imaging device according to claim 14, wherein the scatterer detection module is further configured to:
obtain, based on the differential interference data, candidate SPSs in the target region through an ADI method and a coherence coefficient method;
sort the candidate SPSs according to an ADI value corresponding to the candidate SPSs;
determine a standard candidate SPS according to a sorting result, and determine the standard candidate SPS as a seed point;
compare the distances between each candidate SPS and the seed point with a preset distance threshold, and determine the unnetworked candidate SPSs according to a comparison result;
sort the distances between the unnetworked candidate SPSs and the seed point, and determine a target candidate SPS according to a sorting result;
establish a connection relationship between the target candidate SPS and the seed point to remove an APS based on an interference phase between the target candidate SPS and the seed point;
verify the connection relationship by reconstructing a normalized tomography, when the APS is removed; and
construct the preset region growth network according to the verification result, and detect the reliable SPSs in the target region corresponding to the target interference measurement data through the preset region growth network.

16. The regional five-dimensional imaging device according to claim 15, wherein the scatterer detection module is further configured to:
in response to that the detected maximum scan value exceeds a preset scan threshold, determine the connection relationship as a connection arc between the reliable SPSs in the target region corresponding to the target interference measurement data; and
add the target candidate SPS to a reference network based on the connection arc to construct the preset region growth network based on the reference network.

17. The regional five-dimensional imaging device according to claim 16, wherein the scatterer detection module is further configured to:
store the target candidate SPS into a to-be-grown node queue;
in response to that a number of candidate SPSs connected to the seed point exceeds a sub-node quantity threshold, or the verification of candidate SPSs within the preset distance threshold from the seed point is completed, determine a queue head element of the to-be-grown node queue as new seed point; and
return to the step of comparing distances between each candidate SPS and the seed point with the preset distance threshold, and determine unnetworked candidate SPSs according to the comparison result, until the to-be-grown node queue is empty.

18. The regional five-dimensional imaging device according to claim 17, wherein the scatterer detection module is further configured to:
obtain a number of scatterers for remaining candidate SPSs outside the preset region growth network, and a total number of scatterers for all the candidate SPSs in the target region;
determine a coverage indicator value of the target region based on the number of scatterers and the total number of scatterers;
compare the coverage indicator value with a preset coverage indicator threshold; and
in response to that the coverage indicator value does not exceed the coverage indicator threshold, construct the new preset region growth network based on the remaining candidate SPSs.

19. The regional five-dimensional imaging device according to claim 18, wherein the scatterer detection module is further configured to:
in response to that a number of the preset region growth networks exceeds a preset network quantity threshold, obtain target candidate SPS pairs between the preset region growth networks;
sort the distances between the target candidate SPS pairs, and verify the target candidate SPS pairs according to a sorting result; and
determine whether the target candidate SPS pairs belong to the reliable SPSs according to a verification result.

20. A non-transitory computer-readable storage medium, wherein a regional five-dimensional imaging program is stored on the non-transitory computer-readable storage medium, and the regional five-dimensional imaging program, when executed by a processor, implements the regional five-dimensional imaging method according to claim 1.
